(19) United States
(12) Patent Application Publication
(10) Pub. No.: US 2025/0240268 A1
(43) Pub. Date: Jul. 24, 2025

(54) CONVERGED IP ADDRESS MANAGEMENT ACROSS NETWORKS

(71) Applicant: CABLE TELEVISION LABORATORIES, INC., Louisville, CO (US)

(72) Inventors: OMKAR SHRIPAD DHARMADHIKARI, Centennial, CO (US); JOHN C. BAHR, Superior, CO (US); NEEHARIKA JESUKUMAR, Snoqualmie, WA (US)

(21) Appl. No.: 19/030,534

(22) Filed: Jan. 17, 2025

Related U.S. Application Data
(60) Provisional application No. 63/622,873, filed on Jan. 19, 2024.

(51) Int. Cl. H04L 61/5014; H04L 61/5061

(52) U.S. Cl. CPC H04L 61/5014; H04L 61/5061

(57) ABSTRACT

A method of converged IP address allocation between a plurality of networks using different radio access technologies (RATs) and a common IP address pool includes receiving a request for an IP address from a mobile device that has authenticated with any network of the plurality of networks, the dynamic IP address for use during an IP session, forwarding the request for a dynamic IP address to a DHCP/DN-AAA server, receiving an allocated dynamic IP address from the DHCP/DN-AAA server, updating subscriber data for the mobile device with the allocated dynamic IP address, and using the allocated dynamic IP address when the mobile device authenticates to a different network of the plurality of networks before releasing the IP session.

### RELATED APPLICATIONS

This application claims priority to U.S. Provisional Patent Application Ser. No. 63/622,873, titled “CONVERGED IP ADDRESS MANAGEMENT ACROSS NETWORKS,” filed Jan. 19, 2024, which is incorporated herein by reference.

### BACKGROUND

Mobile devices are typically purchased from a company that provisions the device with an international mobile subscriber identity (IMSI) and manages billing and subscriber services, for example. Over time, the companies providing this service have evolved into several different types. These include Mobile Network Operators (MNOs) such as AT&T™ and Verizon™, and Mobile Virtual Network Operators (MVNOs) such as Cricket™ and Boost Wireless™.

In addition to cellular access networks, mobile devices may access other non-cellular networks such as cable, satellite and Wi-Fi™ networks. These networks are typically provided by Multiple System Operators (MSOs), which may also provide cellular services.

As a result of this proliferation of services, a mobile device that is moving from one place to another may connect to multiple networks, both cellular and non-cellular, during the course of a single phone call or use session. Further, the networks may be owned by the same or different service providers or network operators. Seamless transition between networks enhances the user experience.

### SUMMARY

In a first aspect, a method of converged IP address allocation between a cellular network and a second network, the method, executed by the cellular network, includes receiving a request for an IP address from a mobile device connected to the second network with an allocated IP address, forwarding the request for the IP address to an external DHCP/DN-AAA server, receiving the allocated IP address from the external DHCP/DN-AAA server, and updating cellular network subscriber data for the mobile device with the allocated IP address.

The method may also include receiving, by a wireless access point in the second network, a request for an IP address from a user device and forwarding the request to the external DHCP/DN-AAA server.

The cellular network and the second network may be owned by same multiple system operator (MSO) and use different radio access technologies (RATs).

The cellular network and the second network may use a common pool of IP addresses.

The cellular network and the second network are operated by different operators that have an inter-operator agreement.

In another aspect, the cellular network is owned by a mobile network operator (MNO) and the second network is a non-cellular network owned by a multiple system operator (MSO). Further, the cellular network is owned by an MNO and the second network is a cellular network owned by an MSO. In addition, the method may be applied to a third network, wherein the third network is a cellular network owned by the MSO.

In another aspect, a method of converged IP address allocation between a plurality of networks using different radio access technologies (RATs) and a common IP address pool includes receiving a request for a dynamic IP address from a mobile device that has authenticated with any network of the plurality of networks, the dynamic IP address for use during an IP session, forwarding the request for a dynamic IP address to a DHCP/DN-AAA server, receiving an allocated dynamic IP address from the DHCP/DN-AAA server, updating subscriber data for the mobile device with the allocated dynamic IP address, and using the allocated dynamic IP address when the mobile device authenticates to a different network of the plurality of networks before releasing the IP session.

In another aspect, a method of converged IP address allocation between a cellular network and a non-cellular network owned by same multiple system operator (MSO) includes accessing a data network, by a mobile device while connected to the cellular network by sending a request for an IP address to a network function in the cellular network and receiving an allocated IP address from the network function, and accessing the data network, by the mobile device while connected to the non-cellular network by sending the request for an IP address to the network function in the cellular network, and receiving the same allocated IP address from the network function.

Further, the network function is a Unified Data Management (UDM) function.

Additionally, the cellular network and the non-cellular network use a common pool of static IP addresses.

### BRIEF DESCRIPTION OF THE FIGURES

FIG. 1 is a schematic diagram of an architecture for converged IP address management, in embodiments.

FIG. 2 is a schematic diagram of an architecture for converged IP address management, in embodiments.

FIG. 3 is a schematic diagram of an architecture for converged IP address management, in embodiments.

FIG. 4 is a schematic diagram of an architecture for converged IP address management, in embodiments.

FIG. 5 is a flowchart of a method for converged IP address management, in embodiments.

FIG. 6 is a flowchart of another method for converged IP address management, in embodiments.

FIG. 7 is a flowchart of a method for converged IP address management between cellular and non-cellular networks having a common owner, in embodiments.

FIG. 8 is a call flow illustrating IP address allocation in a Wi-Fi network, in embodiments.

### DETAILED DESCRIPTION OF THE EMBODIMENTS

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of embodiments do not represent all implementations consistent with the disclosure. Instead, they are merely examples of apparatuses and methods consistent with aspects related to the disclosure as recited in the appended claims.

A mobile device, or user equipment (UE), that is moving from one place to another may connect to multiple networks during the course of a single phone call or session. The mobile device may move from a cellular network to a non-cellular network, such as a Wi-Fi™ network, and back again during a single phone call or session. In addition, mobile devices use both access networks to gain access to the Internet, which uses a unique Internet Protocol (IP) address to identify the mobile device. Throughout the specification, the terms mobile device and UE may be used interchangeably. Further, the terms Internet and data network may also be used interchangeably.

Service providers of cellular and non-cellular networks are generally understood using the following categories. Representative examples for purposes of illustration are given below, but these are not limiting. Any service provider or network operator may be considered as falling into more than one category, their category may change over time, or new categories may be developed.

MSO=Multiple System Operator. This is generally considered a company that operates multiple cable or satellite television systems, and also internet, voice over IP, data and telecommunications. Some MSOs may also offer cellular services. Examples of MSOs may include Comcast™, DirecTV™, and Dish Networks™.

MNO=Mobile Network Operator. This category includes service providers that own or control access to a radio spectrum license and own or control elements of the cellular network infrastructure necessary to provide services. MNOs may also own back haul infrastructure and provisioning computer systems. Examples of MSOs may include Verizon™ and T-Mobile™.

MVNO=Mobile Virtual Network Operator. This category includes service providers that have access to basic network infrastructure but do not own a spectrum license. Example of MVNOs include Cricket™ and Boost™.

Carrier Wi-Fi=Wi-Fi access points in dense geographic areas that are provided by an operator to increase voice and data bandwidth in a congested area, in particular, to augment cellphone networks, (e.g., Community Wi-Fi)

RAT=Radio Access Technology. This is the underlying physical connection method that mobile devices use to connect to a radio communication network. Examples of RATs include Bluetooth™, Wi-Fi™, and the cellular networks of GSM/UMTS/LET/5G NR.

UDM=Unified Data Management. This is a component of cellular networks that manages subscriber data and authentication processes.

NAT=Network Address Translation. This is a service that enables private IP networks to use the Internet and cloud networks. NAT translates private IP addresses in an internal network to a public IP address before packets are sent to an external network.

WAP=Wi-fi Access Point. A wireless access point (WAP) is a networking device that allows wireless-capable devices to connect to a wired network. For example, a WAP may be incorporated as part of a router although other configurations are contemplated.

WAG=Wi-Fi or Wireless Access Gateway. This is an element in a network that serves to route data packets from a wireless Local Area Network (LAN) to another network. Generally, a WAG refers to a component that is capable of connecting networks that use different protocols. It can convert one protocol to another and provide connection to Internet.

PLMN=Public Land Mobile Network. This is a wireless network that allows mobile devices to communicate and transfer data. It is operated by cellular service providers and accessible to the general public. Typically, PLMNs refers to a specific operator in a specific country and are understood as including components that are Earth-based rather than satellite-based.

NTN=Non-Terrestrial Networks use satellites and other platforms (such as high-altitude platforms (HAPS) and drones) to provide wireless communications above the Earch's surface.

External data network (DN)=a network that is connected to a 5G network via a data network name (DNN). A DNN is similar to an access point name (APN) on a 4G network.

DHCP=Dynamic Host Configuration Protocol. This is a network management protocol that automatically assigns IP addresses and other configuration parameters to devices on a network.

As both cellular and non-cellular networks have evolved, the access points for mobile devices and the allocation of IP addresses by each type of network have diverged. In the case of 5G cellular networks, UE IP address allocation (IPv4 or IPv6) can be either static or dynamic based on subscription information in the UDM (Unified Data Management) or based on the configuration on a per-subscriber, per-DNN (Domain Network Name) basis and per-S-NSSAI (Single Network Slice Selection Assistance Information). The IP address/prefix is delivered to the UE in the same way as a dynamic IP address/prefix and is transparent to the UE whether the PLMN (Public Land Mobile Network) or the external data network allocates the IP address and whether the IP address is static or dynamic.

Static IP address allocation in a cellular network.
1. A static IP address/prefix may be stored in the UDM which the SMF (Session Management Function) retrieves from the UDM during PDU (Protocol Data Unit) Session Establishment procedure.
2. If not stored in the UDM subscription record, the Static IP address/prefix may be configured on a per-subscriber, per-DNN and per-S-NSSAI basis in the DHCP/DN-AAA server which the SMF retrieves from the DHCP/DN-AAA server.

Dynamic IP address allocation in a cellular network.
1. The SMF may allocate the IP address from a pool that corresponds to the PDU Session Anchor (UPF) that has been selected.
2. The UE IP address may be obtained from the UPF (User Plane Function). In that case the SMF selects a UPF based upon feature support via NRF or via N4 capability negotiation during N4 Association Setup and interacts with the UPF via N4 procedures to obtain a suitable IP address. The SMF provides the UPF with the necessary information allowing the UPF to derive the proper IP address (e.g., the network instance).
3. The UE IP address is obtained from the external data network, additionally, the SMF shall also send the allocation, renewal and release related request messages to the external data network, i.e. DHCP/DN-AAA server, and maintain the corresponding state information.

A given IP address pool is typically controlled by a unique entity (either the SMF or the UPF or an external server). The IP address managed by the UPF can be partitioned into multiple IP address pool partition(s), i.e. associated with multiple IP address pool ID(s). UPF may use NAT (Network Address Translation) between the UE and the Data Network, and thus the 5GC allocated (private) UE IP address may not be visible on the N6 reference point.

More detailed information can be found in TS 23.501 that covers the stage 2 aspects of System architecture for the 5G System and more specifically clause 5.8.2.2 that covers the aspects of UE IP Address Management, the disclosure of which is hereby incorporated by reference.

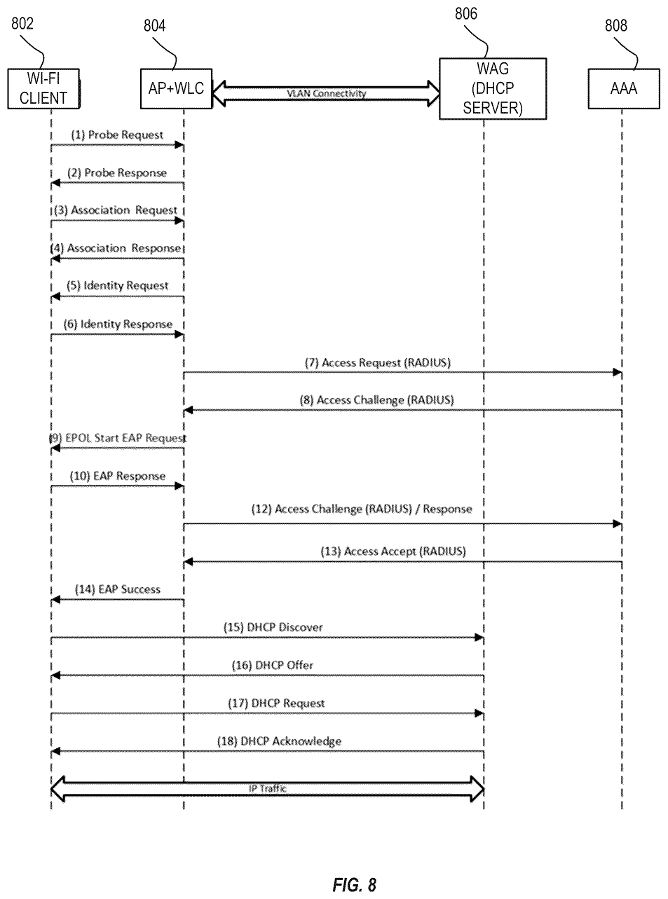

In a Wi-Fi network, IP addresses are typically allocated by a DHCP/AAA server on the non-cellular network after the UE has successfully Authenticated and Associated with the Wi-Fi network. In case of Wi-Fi, the DHCP IP assignment may be accomplished as explained in the call flow of FIG. 8, which shows the interactions between Wi-Fi client 802, Access Point and Wireless LAN Controller (AP+WLC) 804, WAG (DHCP Server) 806 and an AAA server 808. The use of an external data network i.e. DHCP/DN-AAA server for IP address allocation in 5G is described in detail within TS 29.561 that covers the Stage 3 aspects of interworking between 5G Network and external Data Networks, the disclosure of which is hereby incorporated by reference.

In addition to moving between cellular and non-cellular networks, the mobile device may also move between different cellular networks. Further, any of the networks that the mobile device accesses may be owned by the same or different service providers or network operators.

The use of different methods of allocating IP addresses by networks using different RATs and/or by networks having different owners results in several problems. Some representative examples include:

Problem One: An IP address changes typically occur when a user transitions between network types. For example, moving from a cellular network to a Wi-Fi connection often results in a new IP assignment, interrupting ongoing sessions like streaming or gaming. This change impacts applications sensitive to IP continuity.

Solution: A converged IP address management method as disclosed herein allocates a persistent IP address across networks and/or seamlessly manages reallocation without impacting user sessions. Through this, the device retains a stable IP environment even when switching from, say, 5G to home Wi-Fi or fixed broadband. This enables users to roam freely without interruption, enhancing the continuity of services and minimizing issues such as dropped calls.

Problem Two: Traditional IP management requires separate address pools and policies for each network. Managing these independently increases operational complexity, especially for large service providers.

Solution: A converged IP address management method as disclosed herein centralizes IP pool management, dynamically allocating addresses based on user location, device type, and network availability. This simplifies IP oversight, lowers the operational overhead of maintaining separate IP pools, and reduces the volume of redundant IP requests and reassignments. This unified platform makes it easier to comply with IP policies, improves tracking, and reduces operational costs.

Problem Three: Managing IP addresses across different networks in isolation makes security monitoring challenging, as each network may have separate authentication, logging, and tracking mechanisms.

Solution: A converged IP address management method as disclosed herein offers enhanced visibility and control over user activity across networks. Providers can more effectively monitor and secure traffic, enforce compliance policies, and address issues such as IP spoofing or unauthorized access. Additionally, centralizing IP addresses strengthens session tracking, creating a more robust environment for enforcing user authentication and managing permissions.

A technical problem faced by service operators is seamless transition as a mobile device moves between and connects to different networks, particularly with regard to sessions involving Internet or cloud access, i.e., where the mobile device has an allocated IP address. Seamless transition between networks enhances the user experience because it prevents a delay or possible dropped connection. While some network-controlled methods of seamless transitions have been standardized, these are only possible when both the device and the network both support certain features (e.g. ATSSS). In addition, some level of interfacing is needed between the two networks (generally at the core level) when the two networks are operated independently by different service providers. Some examples of transitions between networks include, but are not limited to:

MSO-owned Carrier Wi-Fi and MNO-owned cellular Networks.

MNO-owned Cellular Networks and MSO-owned cellular Networks.

MSO-owned Carrier Wi-Fi and MSO-owned cellular Networks.

MSO-owned Carrier Wi-Fi (e.g. Community Wi-Fi) and MSO-owned (managed or unmanaged) Home Networks (HN). In embodiments, an unmanaged HN refers to a device which the consumer provisions and sets up whereas managed HN refers to a gateway (GW) leased by an MSO.

MSO-owned Carrier Wi-Fi and MNO-owned NTN cellular network.

MSO-owned cellular network and MNO-owned NTN cellular network.

These use cases may expand to the next generation of cellular technologies (6G and beyond), different types of Wi-Fi network implementations (Carrier Wi-Fi, home Wi-Fi, open Wi-Fi, etc.), different types of cellular network implementations (Public, Non-Public, etc.) and other types of technologies such as non-terrestrial networks (NTN)—GEO/LEO/MEO, Bluetooth, light fidelity (Li-Fi), etc.

One common underlying problem when a device transitions between networks, regardless of type, is an IP address change. Whenever the device successfully authenticates with any network, the network assigns the device an IP address to identify the device and perform uplink and downlink data transfer between the device and the data network. Traditionally, devices using separate radios of different RATs (e.g., cellular and Wi-Fi) and devices using a separate UE protocol stack for a single RAT enabling multiple network connection (e.g., dual SIM implementations) face the issue of IP address change when transitioning between networks that results in noticeable service disruption and affects the end user experience.

In an effort to provide better service to subscribers, operators of wireless networks may form inter-operator agreements with other operators. In embodiments, a common converged external data network, i.e., a DHCP/DN-AAA server will be used for IP address allocation that will assign a singular IP address (IPv4/IPv6) to a device using services from its home provider across any of the access network that the home provider owns, operates, or leverages (as part of any business agreement) to serve its subscribers. As discussed herein, any of these relationships or agreements will be referred to as an inter-operator agreement.

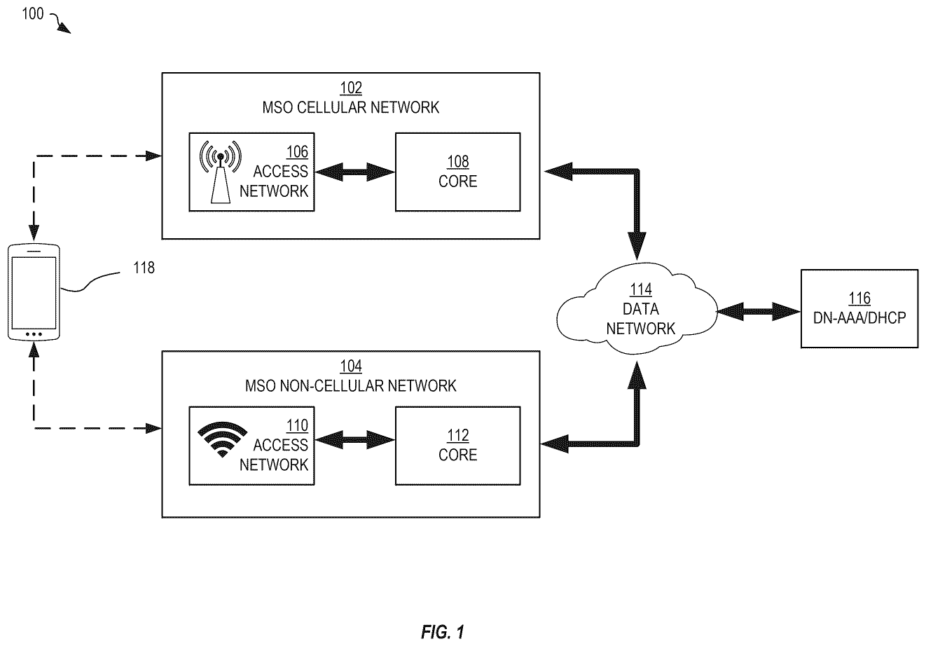

FIGS. 1-4 illustrate various architectures for converged IP address management across networks.

FIG. 1 is a schematic diagram of an architecture 100 for converged IP address management between an MSO-owned cellular network 102 and an MSO-owned non-cellular network 104. In this architecture, both network 102 and network 104 are owned by the same entity but use different RATs. MSO-owned cellular network 102 may be accessed using a protocol defined by the Third Generation Partnership Project (3GPP). It includes access network 106, for example, base stations, which are connected to core 108 which includes various functions to manage the cellular network. Core 108 may be understood as an architecture that controls functions and interactions including authentication, security, session management and aggregation of traffic from end devices.

Non-cellular network 104, such as a Wi-Fi network, includes access network 110 such as WAPs or WAGS, connected to core 112. Core 112 may include routers, switches and other elements that control the flow of traffic between different parts of the network.

Both core 108 and core 112 connect to data network 114, which represents the Internet, or cloud architecture. DN-AAA/DNCP (Domain Name-Authentication, Authorization, Accounting/Dynamic Host Configuration Protocol) server 116 allocates IP addresses for both networks as will be explained in more detail below. Mobile device 118 may connect to data network 114 through either access network 106 or access network 110.

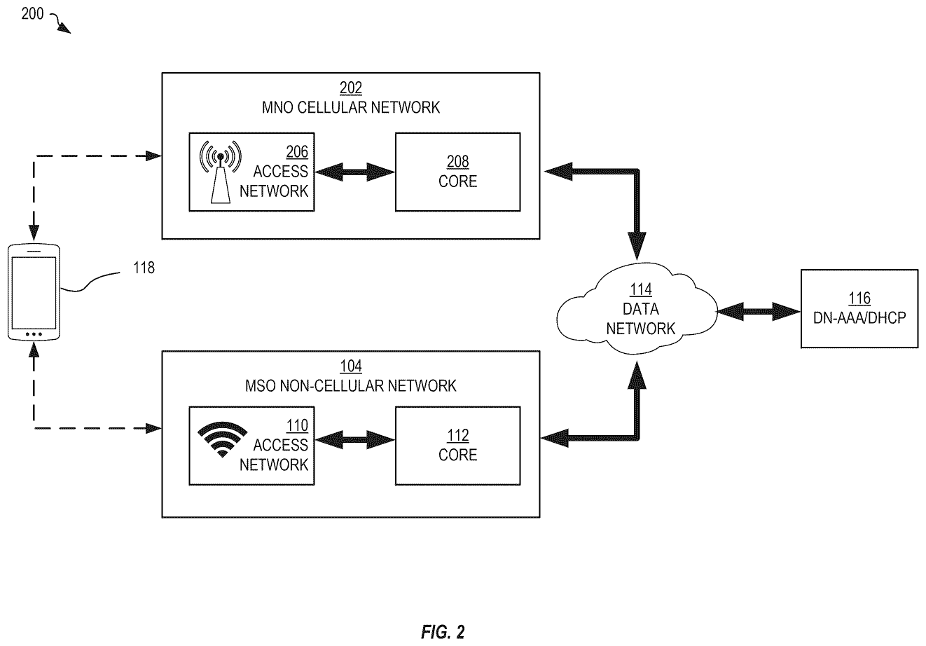

FIG. 2 is a schematic diagram of an architecture 200 for converged IP address management between an MNO-owned cellular network 202 and an MSO-owned non-cellular network 104. In this architecture, both network 102 and network 104 are owned by the different entities and also use different RATs. In embodiments, the MNO and MSO would have an inter-operator agreement. Cellular network 202 includes an access network 206, for example, base stations, which are connected to a core 208 which includes various functions to manage the cellular network. These may be collectively understood as an architecture that controls functions and interactions including authentication, security, session management and aggregation of traffic from end devices.

As described above for FIG. 1, mobile device 118 may connect to data network 114 through either access network 206 or access network 110. DN-AAA/DNCP (Domain Name-Authentication, Authorization, Accounting/Dynamic Host Configuration Protocol) server 116 allocates IP addresses for both networks as will be explained in more detail below.

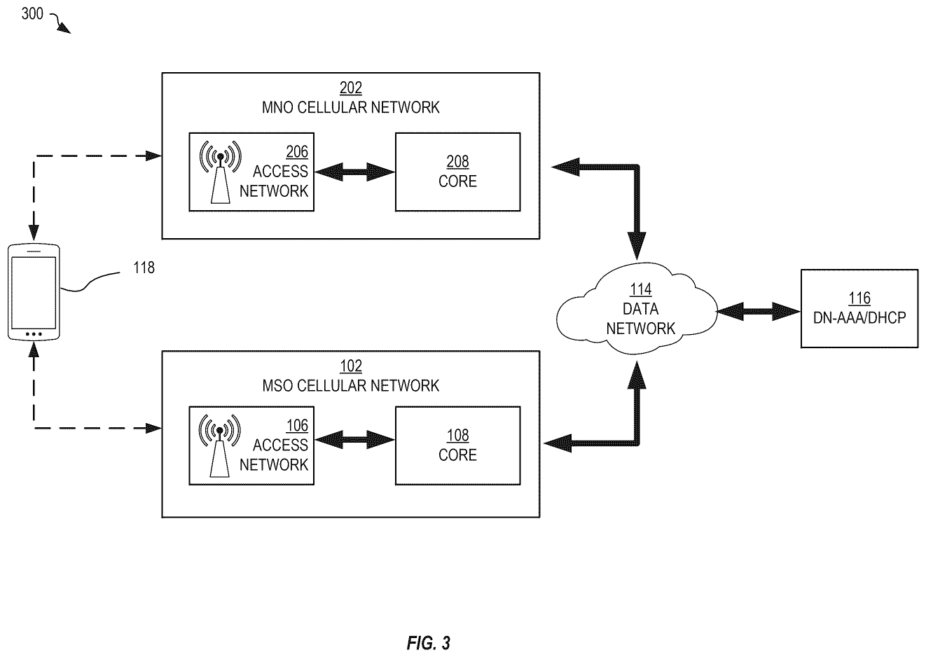

FIG. 3 is a schematic diagram of an architecture 300 for converged IP address management between an MNO-owned cellular network 202 and an MSO-owned cellular network 102. In this architecture, both network 102 and network 104 are owned by the different entities but use the same RAT. In embodiments, the MNO and MSO would have an inter-operator agreement. As described above for FIG. 2, cellular network 202 includes access network 206, for example, base stations, that are connected to a core 208 which includes various functions to manage the cellular network. As described above for FIG. 1, MSO-owned cellular network includes access network 106 and core 108. Mobile device 118 may connect to data network 114 through either access network 206 or access network 106. DN-AAA/DNCP (Domain Name-Authentication, Authorization, Accounting/Dynamic Host Configuration Protocol) server 116 allocates IP addresses for both networks as will be explained in more detail below.

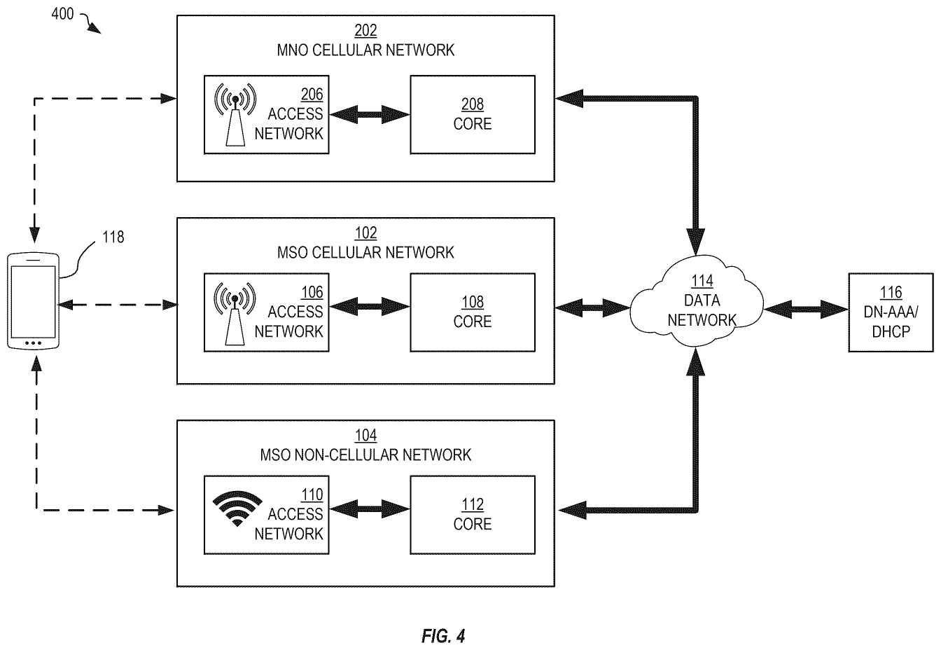

FIG. 4 is a schematic diagram of an architecture 400 for converged IP address management between MNO-owned cellular network 202 and an MSO-owned cellular network 102 and MSO-owned non-cellular network 104. As described above, device 118 may connect to data network 114 through any of access networks 206, 102 and 110. DN-AAA/DNCP (Domain Name-Authentication, Authorization, Accounting/Dynamic Host Configuration Protocol) server 116 allocates IP addresses for both networks as will be explained in more detail below.

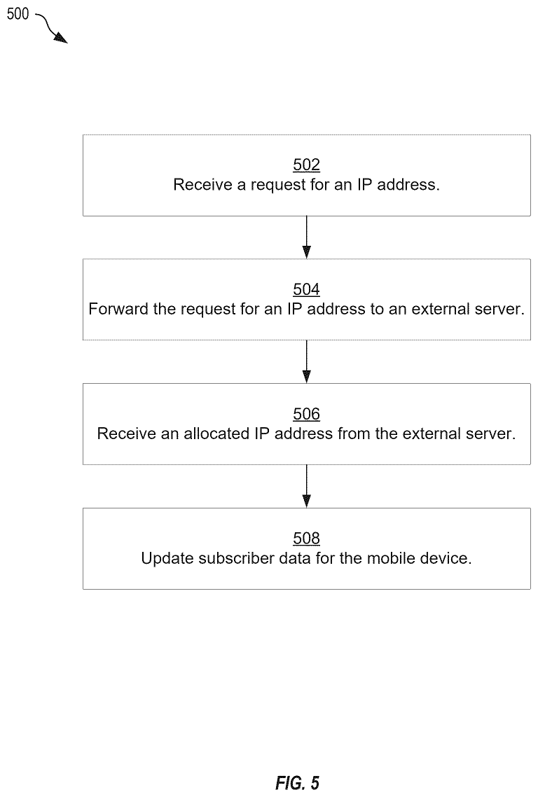

FIG. 5 is a flowchart of a method 500 for converged IP address management between a cellular network and a second network, where the second network may be any of the networks disclosed herein. The method, executed by the cellular network, includes steps 502, 504, 506, and 508. The cellular network and the second network may be owned by the same operator or have an inter-operator agreement.

Step 502 includes receiving a request for an IP address. In an example of step 502, a mobile device 118 that is currently or previously connected to the second network with an allocated IP address from DN-AAA/DNCP server 116 moves into range of access network 106 or 206 and connects to cellular network 102 or 202. In embodiments, mobile device 118 authenticates with core 108 or 208 of cellular network 102 or 202 before requesting an IP address. In further embodiments, core 108 or 208 checks a UDM subscriber record for a stored allocated IP address.

Step 504 includes forwarding the request for an IP address to an external server. In an example of step 504, when core 108 or core 208 does not find an allocated IP address in the UDM subscriber record, the request is forwarded to data network 114 and external DHCP/DN-AAA server 116. An IP address is allocated from a common pool of IP addresses shared by the cellular network and the second network by DHCP/DN-AAA server 116.

Step 506 includes receiving an allocated IP address from the external server. In an example of step 506, core 108 or 208 receives the allocated IP address from the external DHCP/DN-AAA server.

Step 508 includes updating subscriber data for the mobile device. In an example of step 508, the UDM subscriber record maintained in core 108 or 208 for mobile device 118 is updated with the allocated IP address.

In general, IP address allocation in a cellular network may be static or dynamic based on subscription information in the UDM or on configuration information of the core. Static and dynamic IP addresses may be stored/allocated within the cellular network or retrieved from the DHCP/DN-AAA server.

As disclosed herein, cellular networks that are owned by the same operator or have an inter-operator agreement with either other cellular networks or non-cellular networks are configured to use the DHCP/DN-AAA server for all IP address allocation, whether static or dynamic. Once retrieved from the DHCP/DN-AAA server, an allocated IP address may be saved in the UDM subscriber record in the cellular network core.

When a mobile device connects to non-cellular network 104, a request for an IP address is also forwarded to the DHCP/DN-AAA server.

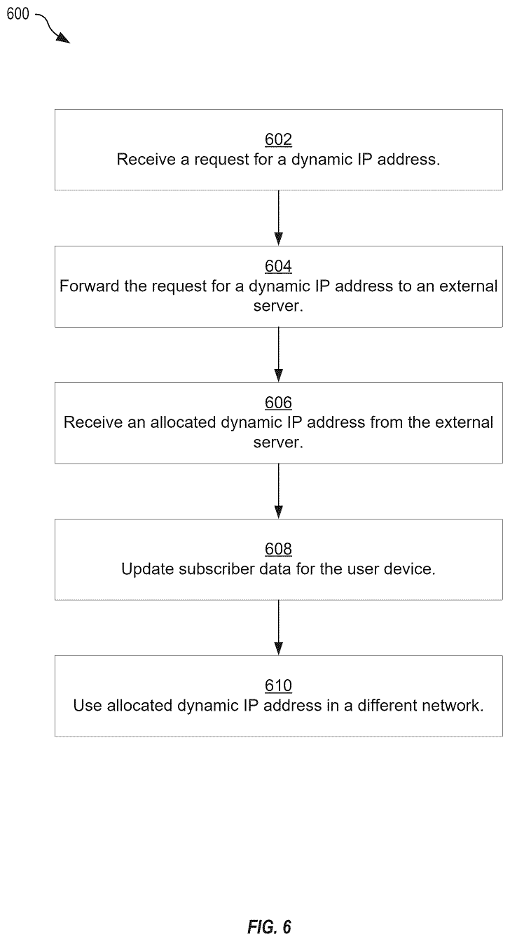

FIG. 6 is a flowchart of another method for converged IP address management between a plurality of networks using different RATs and a common IP address pool. The plurality of networks may have a common owner or have inter-operator agreement. The method includes steps 602, 604, 606, 608, and 610.

Step 602 includes receiving a request for a dynamic IP address. In an example of step 602, a request for a dynamic IP address is received from a mobile device 118 that has authenticated with any network of the plurality of networks and the dynamic IP address is for use during an IP session while connected to data network 114.

Step 604 includes forwarding the request for a dynamic IP address to an external server. In an example of step 604, the external server is a DHCP/DN-AAA server 116.

Step 606 includes receiving an allocated dynamic IP address from the external DHCP/DN-AAA server.

Step 608 includes updating subscriber data for the mobile device 118. In an example of step 608, the UDM subscriber data is updated with the allocated dynamic IP address.

Step 610 includes using the allocated dynamic IP address in a different network. In an example of step 610, the allocated dynamic IP address is used when the mobile device authenticates to a different network of the plurality of networks before releasing the IP session.

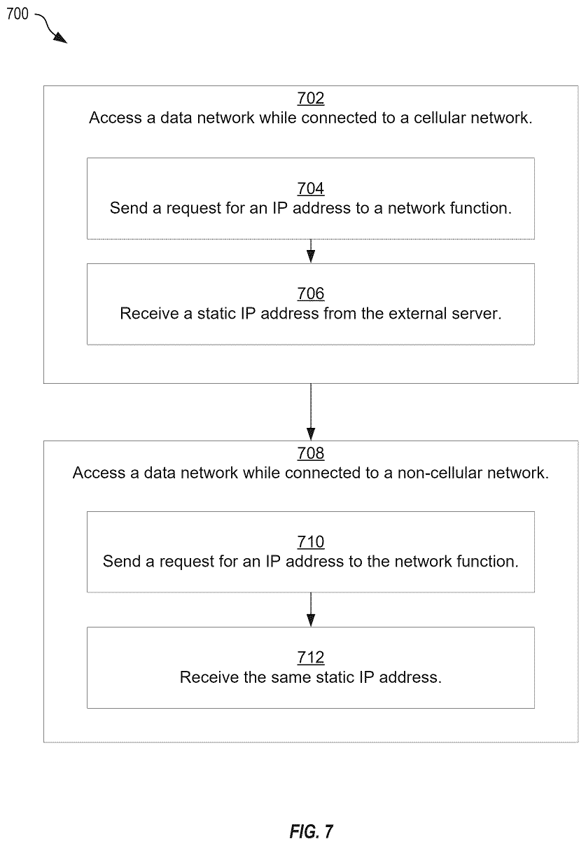

FIG. 7 is a flowchart of a method 700 for converged IP address management between cellular and non-cellular networks having a common owner and using a common pool of static IP addresses. The method includes steps 702, 704, 706, 708, 710, and 712.

Step 702 includes accessing a data network 114, by a mobile device 118 while connected to a cellular network 102, and includes two sub steps, 704 and 706.

Step 708 includes accessing the data network 114, by the mobile device 118 while connected to a non-cellular network 104, and includes two sub-steps, 710 and 712.

Sub-step 704 includes sending a request for an IP address to a network function in the cellular network. In an example of sub-step 704, the mobile device 118 is connected to access network 106 and sends a request to the Unified Data Management (UDM) function in the cellular network core 108.

Sub-step 706 includes receiving a static IP address allocated by the network function.

Sub-step 710 includes sending a request for an IP address to the network function in the cellular network. In an example of sub-step 706, the mobile device 118 is connected to access network 110 in the non-cellular network 104 and sends a request to the Unified Data Management (UDM) function in the cellular network core 108. While the mobile device is connected to the access network 110 of the non-cellular network, core 112 of non-cellular network 104 will interface with the UDM function via NSWOF (Non-Seamless WLAN Offload Function), in embodiments.

Sub-step 712 includes receiving the same static IP address from the network function.

Embodiments disclosed are not limited to the particular networks discussed herein. Development of cellular networks referred to as 6G is ongoing. In a 6G network, the entity that is being used to assign IP addresses to end devices across networks may be part of a converged IP address management (IPAM) platform. The disclosed approach of centralizing IP address assignment and management provides improved user experience as users demand uninterrupted connectivity while moving between networks, often in real-time.

IPv6 may be used due to its expanded address space, allowing for unique address allocations for a vast array of devices across different radio access technologies.

Network functions like the Access and Mobility Management Function (AMF) in 5G networks may be expanded to interact directly with the converged IPAM platform for streamlined IP continuity.

Standardized protocols and APIs between the converged IPAM and core network functions (e.g., user plane and control plane functions in 5G) may be developed to ensure a smooth IP handover between networks, especially with the complexity that multi-access technologies introduce.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method of converged IP address allocation between a cellular network and a second network, the method, executed by the cellular network, comprising:
receiving a request for an IP address from a mobile device connected to the second network with an allocated IP address;
forwarding the request for the IP address to an external DHCP/DN-AAA server;
receiving the allocated IP address from the external DHCP/DN-AAA server; and
updating cellular network subscriber data for the mobile device with the allocated IP address.

2. The method of claim 1, further comprising:
receiving, by a wireless access point in the second network, a request for an IP address from a user device; and
forwarding the request to the external DHCP/DN-AAA server.

3. The method of claim 1, wherein the cellular network and the second network are owned by same multiple system operator (MSO) and use different radio access technologies (RATs).

4. The method of claim 3, wherein the cellular network and the second network use a common pool of IP addresses.

5. The method of claim 1, wherein the cellular network and the second network are operated by different operators that have an inter-operator agreement.

6. The method of claim 5, wherein the cellular network is owned by a mobile network operator (MNO) and the second network is a non-cellular network owned by a multiple system operator (MSO).

7. The method of claim 5, wherein the cellular network is owned by an MNO and the second network is a cellular network owned by an MSO.

8. The method of claim 7, further comprising a third network, wherein the third network is a cellular network owned by the MSO.

9. A method of converged IP address allocation between a plurality of networks using different radio access technologies (RATs) and a common IP address pool, the method comprising:
receiving a request for a dynamic IP address from a mobile device that has authenticated with any network of the plurality of networks, the dynamic IP address for use during an IP session;
forwarding the request for a dynamic IP address to a DHCP/DN-AAA server;
receiving an allocated dynamic IP address from the DHCP/DN-AAA server;
updating subscriber data for the mobile device with the allocated dynamic IP address; and
using the allocated dynamic IP address when the mobile device authenticates to a different network of the plurality of networks before releasing the IP session.

10. A method of converged IP address allocation between a cellular network and a non-cellular network owned by same multiple system operator (MSO), the method, executed by the cellular network, comprising:
accessing a data network, by a mobile device while connected to the cellular network by:
sending a request for an IP address to a network function in the cellular network; and
receiving an allocated IP address from the network function; and
accessing the data network, by the mobile device while connected to the non-cellular network by:
sending the request for an IP address to the network function in the cellular network; and
receiving the same allocated IP address from the network function.

11. The method of claim 10, wherein the network function is a Unified Data Management (UDM) function.

12. The method of claim 10, wherein the cellular network and the non-cellular network use a common pool of static IP addresses.
